(19) United States
(12) Patent Application Publication
(10) Pub. No.: US 2007/0110108 A1
(43) Pub. Date: May 17, 2007

(54) Apparatus for communicating frame control header in wireless access communication system and method thereof

(75) Inventors: Byung-Tae Kang, Seoul (KR); Yun-Sang Park, Suwon-si (KR); Bong-Gee Song, Seongnam-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/600,431

(22) Filed: Nov. 16, 2006

(30) Foreign Application Priority Data
Nov. 16, 2005 (KR) 2005/0109587

(51) Int. Cl. H04J 3/06

(52) U.S. Cl. 370/515

(57) ABSTRACT

An apparatus for communicating a frame control header (FCH) in a wireless access communication system and a method thereof are provided. The apparatus for receiving the FCH includes an information generator for generating information on the FCH, an adder for adding an error check code of a predetermined length to the information bit stream received from the information generator to output an information bit stream, a modulation symbol generator for coding and modulating the information bit stream received from the adder to generate modulation symbols, and an operator for mapping the modulation symbols received from the modulation symbol generator to predetermined slots to perform inverse fast Fourier transform (IFFT) operation.

### PRIORITY

This application claims priority under 35 U.S.C. §119 to an application filed in the Korean Intellectual Property Office on Nov. 16, 2005 and assigned Serial No. 2005-109587, the contents of which are incorporated herein by reference.

### BACKGROUND OF THE INVENTION

1. Field of the Invention

The present invention relates generally to a wireless access communication system, and in particular, to an apparatus for communicating a frame control header (FCH) in an Orthogonal Frequency Division Multiple Access (OFDMA) communication system and a method thereof.

2. Description of the Related Art

OFDMA technology is a multiple access radio communication method using a multi subcarrier and the core technology of the next generation communication systems due to a frequency efficiency and a transmission rate that are higher than those of a conventional communication system using a single subcarrier.

When OFDMA technology is used, a receiver requires mobile allocation port (MAP) information positioned in the first half of an OFDMA frame in order to determine the assigned position (or resources) of a data burst on which traffic is actually loaded. Also, the position of the MAP is determined by 24-bit information referred to as a frame control header (FCH). That is, the receiver first decodes the FCH to determine the position of the MAP, decodes the MAP of the corresponding position, and then extracts the data burst. When the time required to decode the FCH and the MAP increases, the performance of a system can deteriorate. Since the FCH is assigned over 2 OFDMA symbols in the current IEEE 802.16 standard based system, the receiver completes the buffering the 2 OFDMA symbols and then, decodes the FCH. In this case, unnecessary decoding delay can be eliminated.

Table 1 illustrates the field structure of the FCH messages used for the IEEE 802.16 based system.

TABLE 1

| Syntax | Size | Notes |
|---|---|---|
| Frame_Control_Header( ){ | | |
| Used Subchannel bitmap | 6 bits | Bit0: Group0(subch 0˜5) |
| | | Bit1: Group1(subch 6˜9) |
| | | Bit0: Group0(subch 10˜15) |
| | | Bit1: Group1(subch 16˜19) |
| | | Bit0: Group0(subch 20˜25) |
| | | Bit1: Group1(subch 26˜29) |
| Ranging_Change_Indications | 1 bit | |
| Repetition_Coding_Indication | 2 bits | Repetition coding on DL-MAP |
| | | 00-No Repetition |
| | | 01-Repetition coding of 2 |
| | | 10-Repetition coding of 4 |
| | | 11-Repetition coding of 6 |
| Coding_Indication | 3 bits | 0b000 - CC |
| | | 0b001 - BTC |
| | | 0b010 - CTC |
| | | 0b011 - ZT CC |
| | | 0b100 to 0b111 - Reserved |
| DL_Map_Length | 8 bits | Number of subchannels for |
| | | DL_MAP |
| Reserved | 4 bits | Shall be set to zero |
| } | | |

As illustrated in Table 1, FCH information is composed of 24 bits and is repeated once to be increased to 48 bits, and then is coded to a convolutional code (CC). Since the used code rate is ½, the coded data increases to 96 bits. The 96 bit is modulated by a quadrature phase shift keying (QPSK) method and is repeated 4 times to be increased to 192 bits. 192 subcarriers are required to transmit the FCH information.

In general, since one slot is composed of 48 subcarriers (1 subchannel×2 OFDMA symbols) in the IEEE 802.16 based system, in order to transmit the FCH, 4 slots are required. The 4 slots are assigned in one frame of the OFDMA system as illustrated in FIG. 1. The abscissa (x axis) represents a symbol index and the ordinate (y axis) represents a subchannel index. As illustrated in FIG. 1, a preamble is assigned to a first symbol in the frame, the FCH is assigned to second and third symbols in the frame, and the assigned positions (or regions) are predetermined.

FIG. 2 illustrates a method of assigning the 192-bit FCH data to the subcarrier. As illustrated in FIG. 2, 24 bits are first assigned to the ordinate axis for the first OFDMA symbol and 24 bits are continuously assigned to the second OFDMA symbol. Then, 24 bits are assigned to the first OFDMA symbol again and 24 bits are assigned to the second OFDMA symbol again. At this time, the data assigned to the 4 slots are repeated in units of symbols as well as in units of slots.

FIG. 3 illustrates an apparatus for decoding the FCH in a conventional OFDMA communication system. As illustrated in FIG. 3, the conventional apparatus for decoding the FCH includes a buffer 300, a demodulator 302, a convolutional decoder 304, a selector 306, and an FCH information analyzer 308.

Referring to FIG. 3, the radio frequency (RF) signal received through an antenna (not shown) is converted into base band sample data and the sample data is fast Fourier transform (FFT) operated and is stored in the buffer 300. That is, the subcarrier values obtained after performing the FFT operation are stored. The buffer 300 outputs the FCH data among data on the buffered 2 OFDMA symbols in units of slots when the buffering of the 2 OFDMA symbols is sensed after the preamble. That is, the 192-bit data that constitutes the FCH is output in units of 48 bits.

The demodulator 302 demodulates data from the data buffer 300 to output log likelihood ratios (LLR). The convolutional decoder 304 combines the LLRs corresponding to one slot that are output from the demodulator 302 into one subchannel and soft decision decodes the combined data to generate an information bit stream (24 bits). The selector 306 compares the information bit streams for 4 subchannels that are generated by the decoder 304 with each other, and provides the information bit stream that occupies the most space to the FCH information analyzer 308. Then, the FCH information analyzer 308 decodes the information bit stream received from the selector 306 to acquire the FCH information (for example: the position on MAP information).

In the above-described method illustrated in FIG. 3, the respective subchannels are decoded to select the information bit stream that occupies the most space. Data is demodulated in units of slots to be combined into one subchannel, and then the subchannel is decoded to obtain the FCH information.

In the above-described conventional methods, since the FCH is assigned to the 2 OFDMA symbols, after the buffering of the 2 OFDMA symbols is completed, the FCH is decoded. However, as described above, since the FCH is repeated in units of the OFDMA symbols as well as in units of the slots, it is possible to obtain desired information by only decoding the data of the first OFDMA symbol. When information items on the 2 OFDMA symbols are combined with each other, better performance is obtained in the case where a channel environment is poor. In the case where the channel environment is not poor, it can cause unnecessary delay to buffer the 2 OFDMA symbols occupied by the FCH and then, to decode the buffered 2 OFDMA symbols. Also, delay of the decoding of the FCH causes delay of the decoding of the MAP. When the decoding of the MAP is delayed, since the continuously received OFDMA symbols must be buffered, a large capacity of memory is required and the performance of the system deteriorates due to processing delays.

### SUMMARY OF THE INVENTION

An aspect of the present invention is to substantially solve at least the above problems and/or disadvantages and to provide at least the advantages below. Accordingly, an aspect of the present invention is to provide an apparatus for reducing time for decoding a frame control header (FCH) in a wireless access communication system and a method thereof.

Another aspect of the present invention is to provide an apparatus for decoding an FCH using an OFDMA symbol data in a wireless access communication system and a method thereof.

Still another aspect of the present invention is to provide an apparatus for communication FCH messages including an error check code in a wireless access communication system and a method thereof.

In order to achieve the above aspects, according to a first aspect of the present invention, an apparatus for transmitting a frame control header (FCH) in a wireless access communication system includes an information generator for generating information for the FCH, an adder for adding an error check code to the information received from the information generator to output an information bit stream, a modulation symbol generator for coding and modulating the information bit stream to generate modulation symbols, and an operator for mapping the modulation symbols to predetermined slots to perform an inverse fast Fourier transform (IFFT) operation.

According to a second aspect of the present invention, an apparatus for transmitting a frame control header (FCH) in a wireless access communication system includes a demodulator for demodulating data on a first OFDMA symbol among the OFDMA symbols to which the FCH is mapped to generate log likelihood ratios (LLR), a restoring unit for decoding the LLRs to generate an information bit stream, an error checker for detecting an error check code from the information bit stream and providing the information bit stream to an information analyzer when the error check code is normal, and the information analyzer for decoding the information bit stream received from the error checker to obtain information on the FCH.

According to a third aspect of the present invention, a method for transmitting an FCH in a wireless access communication system includes adding an error check code to the information bit stream of the FCH, coding and modulating the information bit stream to which the error check code is added to generate modulation symbols, and mapping the modulation symbols to slots to perform an IFFT operation.

According to a fourth aspect of the present invention, a method of receiving an FCH in a wireless access communication system includes demodulating data on a first OFDMA symbol among the OFDMA symbols to which the FCH is mapped to generate LLRs, decoding the generated LLRs to generate an information bit stream, detecting an error check code from the information bit stream and determining if the error check code is normal, and decoding the information bit stream to obtain FCH information when the error check code is normal.

### BRIEF DESCRIPTION OF THE DRAWINGS

The above and other objects, features and advantages of the present invention will become more apparent from the following detailed description when taken in conjunction with the accompanying drawings in which:

FIG. 1 illustrates the structure of a frame in a wireless access communication system;

FIG. 2 illustrates a method of assigning a frame control header (FCH) data to a subcarrier;

FIG. 3 illustrates an apparatus for decoding the FCH in an OFDMA communication system;

FIG. 4 illustrates an apparatus for generating the FCH in a wireless access communication system according to the present invention;

FIG. 5 illustrates an apparatus for decoding the FCH in a wireless access communication system according to the present invention;

FIG. 6 illustrates processes of decoding the FCH in a wireless access communication system according to the present invention;

FIG. 7A illustrates time for decoding the FCH according to the conventional art;

FIG. 7B illustrates time for decoding the FCH when the error check is normal according to the present invention; and

FIG. 7C illustrates time for decoding the FCH when the error check is normal according to the present invention.

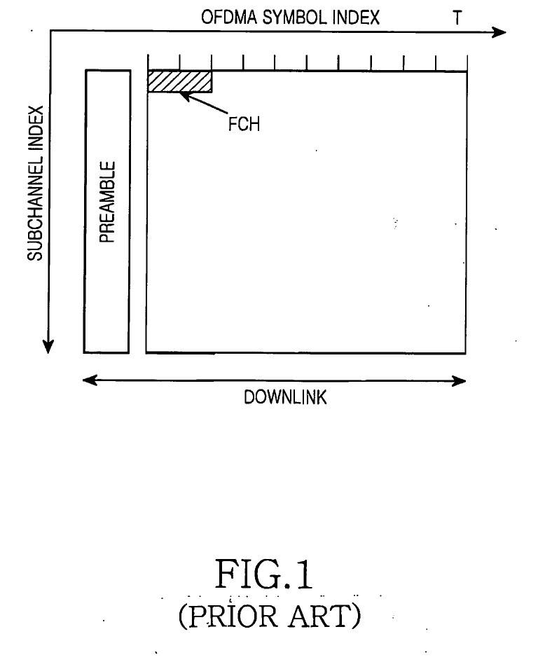

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

The present invention provides a technique for effectively communicating a frame control header (FCH) in a wireless access communication system. The transmission of FCH messages including an error check code and the reception and decoding the FCH using an OFDMA symbol will be described.

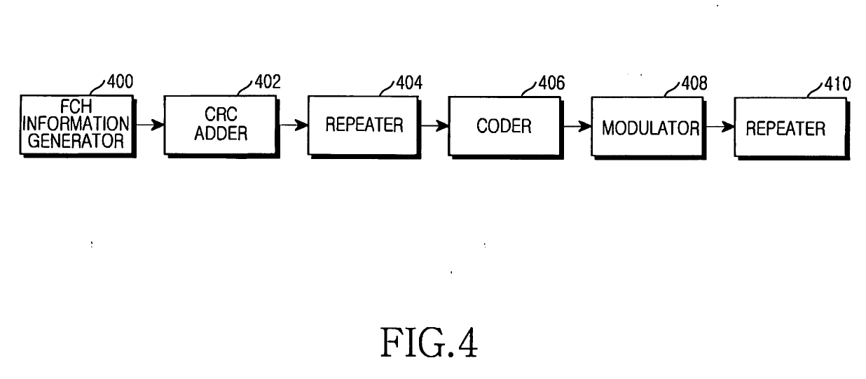

FIG. 4 illustrates an apparatus for generating the FCH in a wireless access communication system according to the present invention.

As illustrated in FIG. 4, the FCH generating apparatus according to the present invention includes an FCH information generator 400, a cyclic redundancy check (CRC) adder 402, a repeater 404, a coder 406, a modulator 408, and a repeater 410.

Referring to FIG. 4, the information generator 400 generates FCH information in accordance with a standard specification. As illustrated in Table 1, the FCH information includes used subchannel bitmap information (6 bits), ranging change indication information (1 bit), DL-MAP repetition coding indication information (2 bits), coding indication information (3 bits), and DL-MAP length information (8 bits).

The CRC adder 402 generates the error check code of a predetermined length for the information bit stream received from the information generator 400 and adds the error check code to the information bit stream to output an information bit stream. A forward error correction (FEC) code like the CRC code can be used as the error check code.

The repeater 404 twice repeats the information bit stream received from the CRC adder 402 to output an information bit stream. The coder 406 codes the information bit stream received from the repeater 404 in a predetermined code rate to generate coding symbols. It is assumed that the coder 406 is a convolutional coder and that the code rate is ½.

The modulator 408 modulates the code symbols received from the coder 406 into a predetermined modulation method to generate modulation symbols. It is assumed that the modulator 408 uses a quadrature phase shift keying (QPSK) modulation method. The repeater 410 repeats the modulation symbols received from the modulator 408 4 times to output modulation symbols.

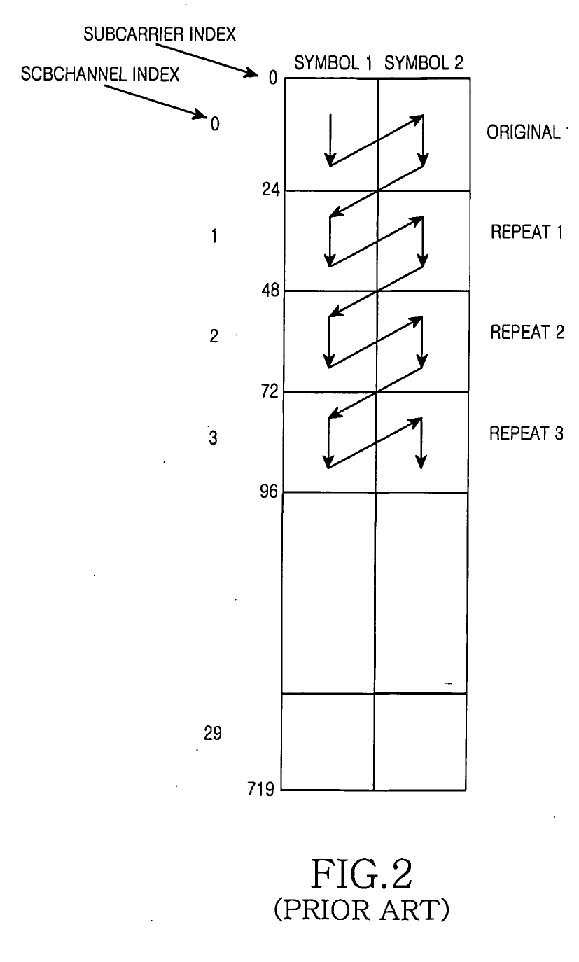

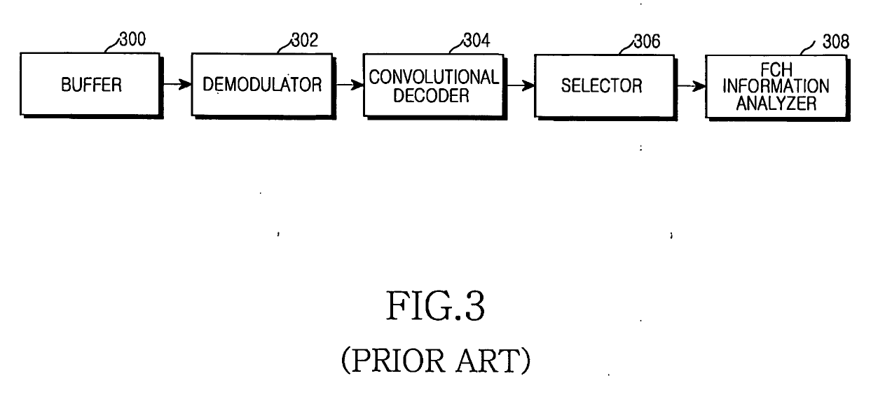

For example, when the number of information bits generated by the information generator 400 is 20 and the number of bits of the error check code added by the CRC adder 402 is 4, the number of modulation symbols finally generated by the repeater 410 is 192. The generated 192 modulation symbols are assigned to 4 slots to be transmitted as illustrated in FIG. 2. The data assigned to the 4 slots is repeated in units of symbols as well as in units of slots. Therefore, the receiver can obtain the FCH information only by decoding the data on a first OFDMA symbol. The operation of the receiver will be described using the above-described example.

The modulation symbols generated by the repeater 410 are mapped to the corresponding subcarriers, to be inverse fast Fourier transform (IFFT) operated, and the IFFT operated data (sample data) is converted into an analog signal, and then is radio frequency (RF) processed to be transmitted through an antenna.

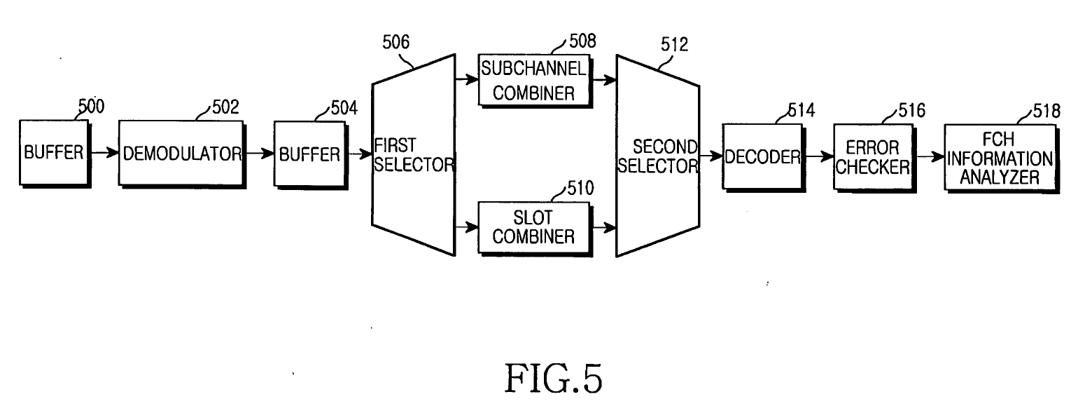

FIG. 5 illustrates an apparatus for decoding the FCH in a wireless access communication system according to the present invention.

As illustrated in FIG. 5, the FCH decoding apparatus according to the present invention includes a buffer 500, a demodulator 502, a log likelihood ratio (LLR) buffer 504, a first selector 506, a subchannel combiner 508, a slot combiner 510, a second selector 512, a decoder 514, an error checker 516, and an FCH information analyzer 518.

Referring to FIG. 5, the RF signal received through an antenna (not shown) is converted into base band sample data and the sample data is FFT operated to be stored in the buffer 500. The FFT operated subcarrier values are stored in the buffer 500. According to the present invention, the buffer 500 outputs FCH data among data items on the first OFDMA symbol in units of subchannels. The 96 bit data assigned to the first symbol is output in units of 24 bits.

The demodulator 502 demodulates the data received from buffer 500 in a predetermined method to generate LLRs. The LLR buffer 504 buffers the LLRs received from the demodulator 502 to output the buffered LLRs to the first selector 506.

The first selector 506 controls an upper controller (not shown) to provide the LLRs received from the LLR buffer 504 to the subchannel combiner 508 or the slot combiner 510. When the first OFDMA symbol of the FCH is decoded, the first selector 506 provides the input LLRs to the subchannel combiner 508.

The subchannel combiner 508 combines the LLRs received from the first selector 506 in units of the subchannels to output LLRs. Four (4) subchannels are combined into one subchannel so that the one subchannel is output.

The slot combiner 510 combines the LLRs received from the first selector 506 in units of the slots, and then combines in units of the subchannels to output LLRs. The slot combiner 510 operates when the first OFDMA symbol of the FCH fails to be decoded.

The second selector 512 selects one of the outputs of the subchannel combiner 508 and the slot combiner 510 to output the selected one under the control of the controller. The decoder 514 soft decision decodes the LLRs received from the second selector 512 to generate information bit stream. The decoder 514 generates the FCH information (24 bits) transmitted by the transmitter.

The error checker 516 detects the error check code (4 bits) from the information bit stream received from the decoder 514 and determines if an error is generated in the information bit stream using the detected error check code.

When it is determined that no error is generated, the error checker 516 provides the information bit stream received from the decoder 514 to the FCH information analyzer 518. The FCH information analyzer 518 decodes the information bit stream received from the error checker 516 to obtain the FCH information (for example: the position of the MAP information).

When it is determined that an error is generated, the error checker 516 generates a control signal so that the buffer 500 generates data on the second OFDMA symbol of the FCH. The buffer 500 outputs the data on the second OFDMA symbol of the FCH in units of the subchannels. The 96 bit data assigned to the second OFDMA symbol is output in units of 24 bits.

The demodulator 502 demodulates the data received from the buffer 500 to generate the LLRs. The LLR buffer 504 buffers the LLRs received from the demodulator 502 and outputs the LLRs of the first OFDMA symbol and the LLRs of the second OFDMA symbol to the first selector 506. The first selector 506 provides the LLRs received from the LLR buffer 504 to the slot combiner 510.

The slot combiner 510 combines the LLRs received from the first selector 506 in units of the slots and then, combines the LLRs in units of the subchannels to output LLRs. Since the processes after the process performed by the slot combiner 510 are the same as described above, detailed description thereof will be omitted. When the FCH is decoded by the 2 OFDMA symbols, the operation of the error checker 516 can be omitted.

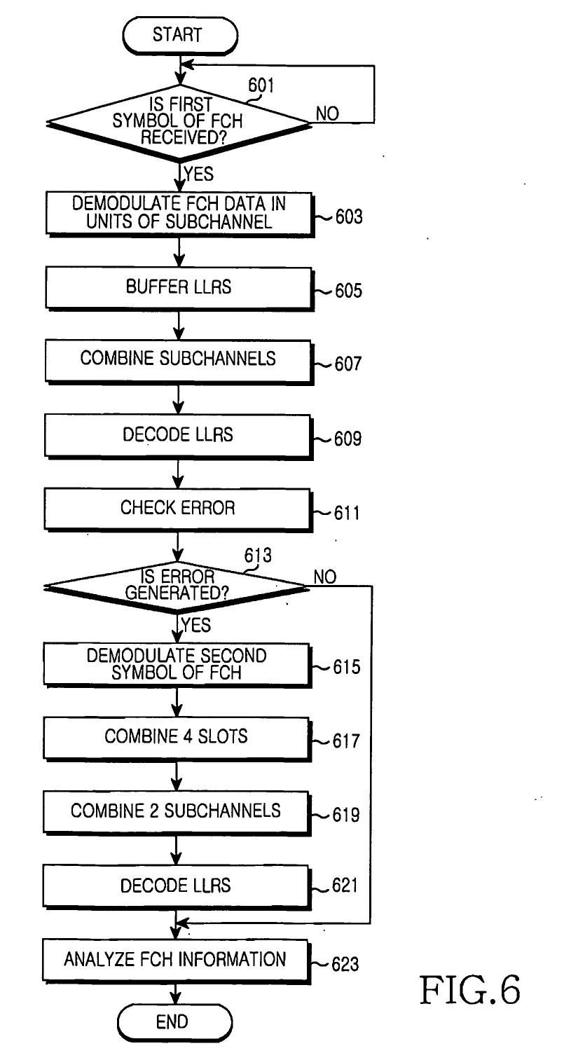

FIG. 6 illustrates processes of decoding the FCH in a wireless access communication system according to the present invention.

Referring to FIG. 6, in step 601, the receiver determines if the first OFDMA symbol of the FCH is received. When the first OFDMA symbol is received, the process proceeds to step 603 in which the receiver demodulates the FCH data assigned to the first OFDMA symbol in units of the subchannels to generate the LLRs. In step 605, the receiver buffers the generated LLRs.

In step 607, the receiver combines the LLRs in units of the subchannels. In step 609, the receiver soft decision decodes the combined LLRs to obtain the information bit stream. The process proceeds to step 611 in which the receiver detects the error check code (4 bits) from the information bit stream and checks an error by the error check code. After is the error check is completed, in step 613, the receiver determines if an error is generated in the information bit stream.

When it is determined that no error is generated, the process proceeds to step 623 in which the receiver analyzes the information bit stream to obtain the FCH information.

When it is determined that an error is generated, the process returns to step 615 in which the receiver demodulates the second OFDMA symbol of the FCH to generate the LLRs. In step 617, the receiver combines the LLRs of the previously generated first OFDMA symbol and the LLRs of the second OFDMA symbol with each other in units of the slots. In step 619, the receiver combines the LLRs of the first OFDMA symbol and the LLRs of the second OFDMA symbol with each other in units of the subchannels.

In step 621, the receiver soft decision decodes the combined LLRs to obtain the information bit stream. In step 623, the receiver analyzes the information bit stream to obtain the FCH information.

As described above, according to the present invention, the FCH is decoded only by the data on the first OFDMA symbol using the repetition characteristic of the FCH. Since the coding gain is reduced in the case where the FCH is decoded only by one OFDMA symbol in comparison with the case where the FCH is decoded by the 2 OFDMA symbols, the programmed 4 bits of the FCH messages are used as the error check code. It is possible to determine if there is an error in the decoded information bit stream (24 bits) using the forward error correction (FEC) code like the CRC code. When it is determined that there is no error, it is determined that the FCH is normally received to directly use the decoding result. However, when it is determined that there is an error, the FCH is decoded by the 2 OFDMA symbols to obtain the FCH information like in the conventional method.

All of the programmed 4 bits of the FCH messages are used as the error check code. The first bit among the 4 bits can be used as the indication bit that determines whether the error check code is used or not, and the remaining 3 bits can be used as the error check code.

The present invention and the conventional art can be compared with each other based on decoding delay time according to the following examples.

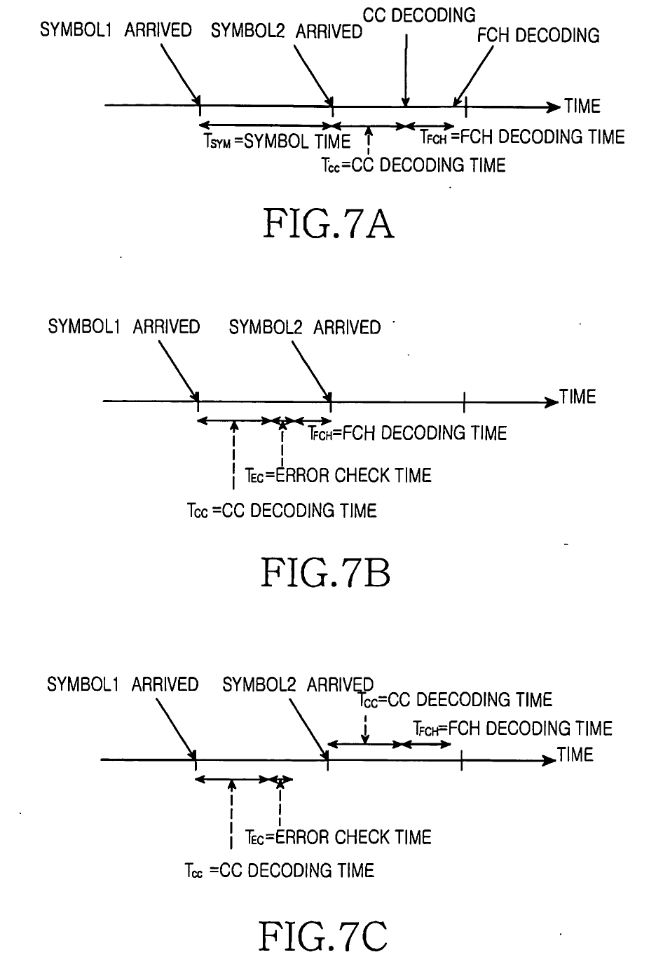

FIGS. 7A to 7C illustrate time for decoding the FCH by the axis of time.

FIG. 7A represents conventional FCH decoding time. FIG. 7B represents FCH decoding time according to the present invention when the error check code is normal. FIG. 7C represents FCH decoding time according to the present invention when the error check code is abnormal. It is assumed that the decoding time is terminated within one symbol distance and the entire processing time for the respective cases are as follows.
Tₜₒₜₐₗ=T_{sym}+T_{CC}+T_{FCH} FIG. 7A
Tₜₒₜₐₗ=T_{CC}+T_{EC}+T_{FCH} FIG. 7B
Tₜₒₜₐₗ=T_{sym}+T_{CC}+T_{FCH} FIG. 7C

When the error check code is normal, it is possible to reduce the delay by T_{sym}−T_{EC} in comparison with the conventional art of FIG. 7A. Since hardware for processing the 4 bit error check code can be simply implemented, according to the present invention, it is possible to reduce the FCH decoding time by adding only a minimum amount of hardware.

As described above, according to the present invention, it is possible to reduce the FCH decoding time. In particular, since the error is checked using the programmed bits of the FCH messages, the hardware can be implemented without violating the forced items of the specification and the hardware is compatible with a system without the above function. As described above, when the FCH decoding time is reduced, since it is possible to rapidly process the MAP information and traffic, it is possible to improve the performance of the entire system.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. An apparatus for transmitting a frame control header (FCH) in a wireless access communication system, the apparatus comprising:
an information generator for generating information for the FCH;
an adder for adding an error check code to the information received from the information generator to output an information bit stream;
a modulation symbol generator for coding and modulating the information bit stream to generate modulation symbols; and
an operator for mapping the modulation symbols to predetermined slots to perform inverse fast Fourier transform (IFFT) operation.

2. The apparatus of claim 1, wherein the error check code is a cyclic redundancy check (CRC) code, and wherein the length of the CRC code is 3 or 4.

3. The apparatus of claim 1, wherein the modulation symbol generator comprises:
a first repeater for repeating the information bit stream to output an information bit stream;
a coder for coding the information bit stream received from the first repeater to generate code symbols;
a modulator for modulating the code symbols to generate modulation symbols; and
a second repeater for repeating the modulation symbols to output modulation symbols.

4. The apparatus of claim 3, wherein a repetition factor of the first repeater is 2, wherein a code rate of the coder is ½, wherein a modulation method of the modulator is a quadrature phase shift keying (QPSK) method, and wherein a repetition factor of the second repeater is 4.

5. The apparatus of claim 3, wherein the coder is a convolutional coder.

6. The apparatus of claim 1, wherein the length of information on the FCH is 20 bits, and wherein the length of the error check code is 4 bits.

7. The apparatus of claim 1, further comprising a radio frequency (RF) processor for RF processing the sample data received from the operator to transmit sample data.

8. An apparatus for transmitting a frame control header (FCH) in a wireless access communication system, the apparatus comprising:
a demodulator for demodulating data on a first Orthogonal Frequency Division Multiple Access (OFDMA) symbol among the OFDMA symbols to which the FCH is mapped to generate log likelihood ratios (LLR);
a restoring unit for decoding the LLRs to generate an information bit stream;
an error checker for detecting an error check code from the information bit stream and providing the information bit stream to an information analyzer when the error check code is normal; and
the information analyzer for decoding the information bit stream received from the error checker to obtain information on the FCH.

9. The apparatus of claim 8, wherein the error check code is a cyclic redundancy check (CRC) code, and wherein the length of the CRC code is 3 or 4.

10. The apparatus of claim 8, wherein the restoring unit comprises:
a combiner for combining the LLRs received from the demodulator in units of subchannels to output LLRs; and
a decoder for soft decision decoding the LLRs received from the combiner to generate an information bit stream.

11. The apparatus of claim 10, wherein the decoder is a convolutional code decoder.

12. The apparatus of claim 10, wherein, when the error check code is abnormal, the demodulator demodulates data on a second OFDMA symbol among the OFDMA symbols to which the FCH is mapped to generate LLRs and further comprises a slot combiner for combining the LLRs of the first OFDMA symbol and the LLRs of the second OFDMA symbol with each other, wherein the decoder soft decision decodes the LLRs received from the slot combiner to generate an information bit stream, and wherein the information analyzer decodes the information bit stream received from the decoder to obtain the FCH information.

13. The apparatus of claim 8, further comprising:
an RF processor for converting an RF signal received through an antenna into base band sample data;
an operator for FFT operating the sample data received from the RF process; and
a buffer for buffering subcarrier values received from the operator to provide the buffered subcarrier values to the demodulator.

14. A method for transmitting a frame control header (FCH) in a wireless access communication system, the method comprising the steps of:
adding an error check code to an information bit stream of the FCH;
coding and modulating the information bit stream to which the error check code is added to generate modulation symbols; and
mapping the modulation symbols to slots to perform an IFFT operation.

15. The method of claim 14, wherein the error check code is a cyclic redundancy check (CRC) code, and wherein the length of the CRC code is 3 or 4.

16. The method of claim 14, wherein the step of generating the modulation symbols comprises:
repeating the information bit stream to which the error check code is added;
coding the repeated information bit stream to generate code symbols;
modulating the code symbols to generate modulation symbols; and
repeating the modulation symbols.

17. The method of claim 15, wherein the information bit stream is repeated twice, wherein a coding rate is ½, wherein a modulating method is a QPSK method, and wherein the modulation symbols is repeated 4 times.

18. The method of claim 15, wherein the coding method is a convolutional coding method.

19. The method of claim 14, wherein the length of information on the FCH is 20 bits, and wherein the length of the error check code is 4 bits.

20. The method of claim 14, further comprising RF processing the sample data obtained after performing the IFFT operation to transmit sample data.

21. A method of receiving an FCH in a wireless access communication system, the method comprising the steps of:
demodulating data on a first OFDMA symbol among the OFDMA symbols to which the FCH is mapped to generate LLRs;
decoding the generated LLRs to generate an information bit stream;
detecting an error check code from the information bit stream and determining if the error check code is normal; and
decoding the information bit stream to obtain FCH information when the error check code is normal.

22. The method of claim 21, wherein the error check code is a cyclic redundancy check (CRC) code, and wherein the length of the CRC code is 3 or 4.

23. The method of claim 21, wherein the step of generating the information bit stream comprises:
combining the generated LLRs in units of subchannels; and
soft decision decoding the combined LLRs to obtain the information bit stream.

24. The method of claim 21, wherein when the error check code is abnormal, the method further comprises:
demodulating data on a second OFDMA symbol among the OFDMA symbols to which the FCH is mapped to generate LLRs;
combining the LLRs of the first OFDMA symbol and the LLRs of the second OFDMA symbol;
soft decision decoding the combined LLRs to obtain an information bit stream; and
decoding the obtained information bit stream to obtain the FCH information.

25. An apparatus for transmitting a frame control header (FCH) in a wireless access communication system, the apparatus comprising:
an information generator for generating information for the FCH;
an adder for adding an error check code to the information received from the information generator to output an information bit stream;
a modulation symbol generator for coding and modulating the information bit stream to generate modulation symbols; and
an operator for mapping the modulation symbols to predetermined slots.

26. An apparatus for transmitting a frame control header (FCH) in a wireless access communication system, the apparatus comprising:
a demodulator for demodulating data on a symbol among the symbols to which the FCH is mapped to generate log likelihood ratios (LLR);
a restoring unit for decoding the LLRs to generate an information bit stream;
an error checker for detecting an error check code from the information bit stream and providing the information bit stream to an information analyzer when the error check code is normal; and
the information analyzer for decoding the information bit stream received from the error checker to obtain information on the FCH.

27. A method for transmitting a frame control header (FCH) in a wireless access communication system, the method comprising the steps of:
adding an error check code to an information bit stream of the FCH;
coding and modulating the information bit stream to which the error check code is added to generate modulation symbols; and
mapping the modulation symbols to slots.

28. A method of receiving an FCH in a wireless access communication system, the method comprising the steps of:
demodulating data on a first symbol among the symbols to which the FCH is mapped to generate LLRs;
decoding the generated LLRs to generate an information bit stream;
detecting an error check code from the information bit stream and determining if the error check code is normal; and
decoding the information bit stream to obtain FCH information when the error check code is normal.
